(19) United States
(12) Patent Application Publication
(10) Pub. No.: US 2005/0228868 A1
(43) Pub. Date: Oct. 13, 2005

(54) Data notification method and system thereof

(76) Inventors: Hiroaki Kawamichi, Tokyo (JP); Hiromitsu Kato, Machida (JP); Junji Nakata, Sagamihara (JP); Katsumi Kawano, Kawasaki (JP); Shigeki Hirasawa, Machida (JP); Shigetoshi Sameshima, Machida (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/104,641

(22) Filed: Apr. 13, 2005

(30) Foreign Application Priority Data
Apr. 13, 2004 (JP) 2004-117799

(51) Int. Cl. G06F 15/16

(52) U.S. Cl. 709/206; 709/203

(57) ABSTRACT

For a group consisting of a plurality of users, data of users who constitute the group is acquired. Thereafter, the users are made to stay in a certain area by determining a user having high importance in the group based on the user data acquired and by providing adequate data to a user having high importance, and then data related to the group is provided. With the arrangement, for a case where a plurality of intended persons are to simultaneously receive data such as advertising and such intended persons form a group, it is possible to effectively notify data in an adequate method.

### CLAIMS OF PRIORITY

The present application claims prority from Japanese application serial no. JP2004-117799, filed on Apr. 13, 2004, the content of which is hereby incorporated by reference into this application.

### BACKGROUND OF THE INVENTION

The present invention relates to a data notification method and a data notification system, and more specifically to a data notification method and a data notification system that are suitable for use when entities to which advertising or data is provided form a group.

As loudspeakers and display units are becoming generic, systems that provide data to those persons located in the vicinity of such device through commercial use of advertising, etc. are offered for practical use. Since provision of data is conducted in a stereotyped manner with those systems, there is a problem in that intended persons who are supposed to receive the data may pass through the device without stopping, and effect of data provision to the intended persons who are supposed to receive the data is not always expected to be high.

The “image display method” described in Japanese Patent Laid-open No. 2002-73321 stated below is one of the measures for improving this problem. The method offers an image display method which can enhance effects of advertising, or effects and values of the displayed image for persons or customers by automatically switching indoor or outdoor advertising displays or image displays according to characteristics of persons, or more specifically to their characteristics as customers.

The above-described prior art is designed to enhance advertising effects by recognizing characteristics of persons who appear in an image taken.

However, the method is designed to display an image by assuming the status of individual person. For a case where the image is utilized by a plurality of users at the same time, therefore, it is difficult to provide data in an adequate method when providing the group of those persons with data.

The present invention has been made to solve the problem of the above-described prior art, and it is an object of the invention to provide data notification method which enables an effective data notification with an adequate method for a case where a plurality of intended persons are supposed to receive data such as advertising at the same time and further such intended persons form a group.

### SUMMARY OF THE INVENTION

In the present invention, data notification devices such as a display unit, a radio station and a data acquisition device such as a camera are installed in a public space of a station, a shopping street, an exhibition hall, etc. Thereafter, profile data of a mobile device owned by an intended person to whom data is notified (hereinafter referred to as the “intended person for data notification”) is acquired via a radio, or positional data is acquired by imaging the intended person for data notification.

Then, based on the data thus acquired on the intended person for data notification, a judgment is made as to whether a plurality of intended persons for data notification form a group or not, and the intended person for data notification who has the highest importance among persons in the group is be determined, by giving the highest importance to the intended person for data notification among all the persons in the group who has the highest authority over the persons in the group.

Then, a judgment is made, based on the positional relationship of the data notification device or the data acquisition device, as to whether or not the intended person for data notification who is determined to have the highest importance in the group is in a staying status at a certain location in the public space. If it is judged that the intended person stays at the location, an action to change the display on the display unit, etc. is taken to enhance the effects of advertising, etc.

With the data notification system, by directing an attention to the intended person for data notification having high importance in the group, changing advertising displays, and giving better viewing of advertisement to the intended person for data notification having high importance, it is possible to make the intended person for data notification having high importance to make a halt and eventually to make the group itself to be in a staying status, thus enabling to enhance notification effects of data on advertising, etc.

As described above, according to the present invention, it is possible to provide a data notification system which enables effective notification of data for a case where a plurality of intended persons receive a notification such as advertising at the same time and such intended persons form a group.

### BRIEF DESCRIPTION OF DRAWINGS

FIG. 1 is a configuration diagram of a data notification system according to a first preferred embodiment of the present invention;

FIG. 2 is a software configuration diagram of the data notification system according to the first embodiment of the present invention;

FIG. 3 is a diagram showing an example of a profile data table to be stored in a profiles DB 8;

FIG. 4 is a diagram showing an example of an image data table to be stored in an images DB 9;

FIG. 5 is a flow chart illustrating processes of the data notification system according to the first embodiment of the present invention (Part 1);

FIG. 6 is a flow chart illustrating processes of the data notification system according to the first embodiment of the present invention (Part 2);

FIG. 7 is a diagram showing an example of a display unit of the data notification system according to the first embodiment of the present invention;

FIG. 8 is a configuration diagram of a data notification system according to a second preferred embodiment of the present invention;

FIG. 9 is a software configuration diagram of the data notification system according to the second embodiment of the present invention; and

FIG. 10 is a flow chart illustrating processes of the data notification system according to the second embodiment of the present invention.

### DESCRIPTION OF THE PREFERRED EMBODIMENT

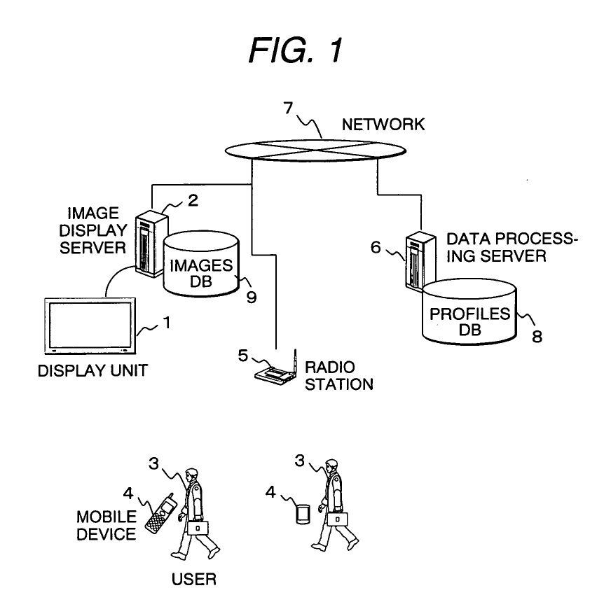

Hereinafter, preferred embodiments according to the present invention will be described with reference to FIGS. 1 to 10.

### First Embodiment

Hereinafter, a first embodiment according to the present invention will be described with reference to FIGS. 1 to 7.

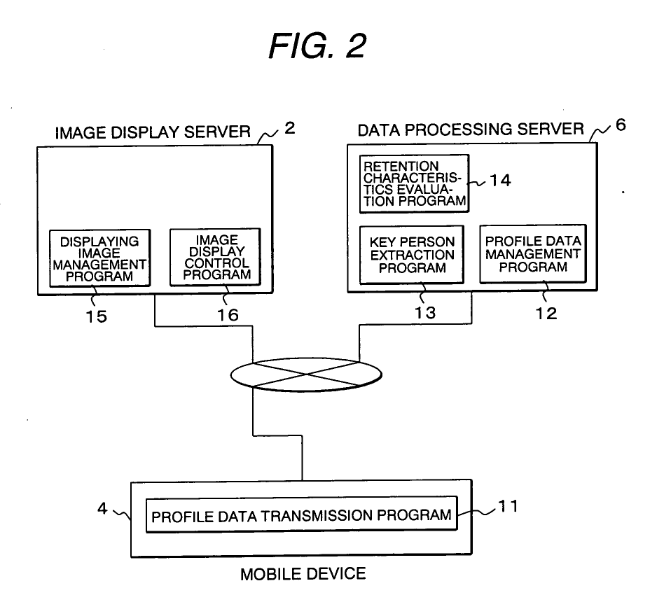

First, configuration of the data notification system according to the first embodiment of the present invention will be described with reference to FIGS. 1 and 2.

FIG. 1 is a configuration diagram of the data notification system according to the first embodiment of the present invention.

FIG. 2 is a software configuration diagram of the data notification system according to the first embodiment of the present invention.

The embodiment refers to a system which, using a display unit installed in a public space to which many users visit, provides and notifies data in a method that is appropriate for the status of a user located in the vicinity of the display unit. Examples of the public space include a station, an exhibition hall and a multi-tenant building.

In the system, a display unit 1 is connected to an image display server 2. Here, data may be provided to visitors by using voices through equipment such as a speaker instead of using the display unit 1. The display unit 1 displays images stored in an images database (DB) 9 in responding to a request from the image display server 2. Then, the data displayed on the display unit 1 is provided to a plurality of users 3 who visit the public space where the display unit 1 is installed.

Here, the data to be displayed on the display unit 1 includes guidance data of the peripheral area and advertising data. One user 3 carries a mobile device 4 which incorporates a computing device and/or a storage device. The mobile device 4 is connected to a data processing server 6 via the radio station 5. The mobile device 4 can be a cell phone, a personal digital assistance (PDA), a radio frequency identification (RF-ID) tag, an integrated circuit (IC) card, etc.

The data processing server 6 acquires data such as age, gender and family structure of the user 3, who carry a mobile device 4, from the mobile device 4 and stores the data in a profiles DB 8. To acquire the data, the user 3 may enter the data, or the profile data of the user 3 who carries the mobile device may be acquired automatically from the mobile device registered in advance.

Data on relationship between users who are presently located in the vicinity of the display unit 1 is acquired, and a judgment is made as to whether the user 3 forms a group or not.

Two methods are available for judging whether the users 3 form a group or not: one method is to judge whether the users 3 belong to one group based on the profile data acquired; and another method is to measure the grouping status based on positional data transmitted from the mobile device 4. With these methods, an assumption that the users 3 form a group can be made when the following conditions are satisfied: A group of the users 3 remains in a certain area for a specific period of time, in a certain area in a specific time zone, or in specific number of areas.

Then, within the group, a user 3 who is determined to have an influential power on actions over persons in the group will be assumed to be a user 3 having high importance. Specific examples of the group, and those of the user 3 having high importance will be described later.

Alternatively, as a means for acquiring data on the users 3, formation of a group by the users 3 may be judged by preparing a camera instead of the radio station 5 and using the image data taken by the camera. In this case, formation of the group will be judged by recognizing the image taken by the camera.

Next, a user having high importance is determined in the group, the formation of which is judged as stated above. The user having high importance in the group should mean the user within the group who has the strongest influential power over the group members. Such user may sometimes be the person who assumes the position as a leader of the group, or otherwise, if family members form a group, a child may sometimes be the user having high importance.

To determine the user having high importance, two methods are available: one method is to refer to profile data; and another method is to use a vital sign that is captured through a camera. With the latter method, for example, it is judged that which user is attracting attentions of other users based on action data such as directions to which users are facing and data on visual lines of users. In addition, the user who is attracting attentions of other users most is assumed to be the user having an influential power on actions, or the user having high importance. Alternatively, a user who has determined, based on data on moving and acting directions of users, to takes the leading position of the group for the longest period of time is assumed to be the user having high importance.

It should be noted that examples of the groups and users having high importance will be described later.

The data processing server 6 is connected to the image display server 2 via a network 7. With the system, to allow the user having high importance in the group to halt, it is designed to enhance notification effect of data in a manner to change data to be displayed, or to change the display methods according to timing before and after the user having high importance in the group makes a halt.

If the user having high importance can be successfully induced to make a halt, other group members will also make a halt. Therefore, it is expected that notification effects of data will be enhanced.

It should be noted that, hereinafter, the status that a user remains in a certain area for a specific period of time shall be referred to as a “staying status.” More specifically, it is intended that, by directing an attention to the status where the user having high importance stays in a certain area when viewed from the data display device 1, displays or methods of notifying data will be changed according to timing before and after the user is in a staying status.

FIG. 2 shows an example of the software configuration of the data notification system.

The mobile device 4 includes a profile data transmission program 11 which keeps data on the users 3 who carry the mobile device 4 and transmits the data to be stored in the profiles DB 9.

The data processing server 6 includes a profile data transmission program 11, a profile data management program 12, a key person extraction program 13 and a staying characteristics evaluation program 14, as software to be executed thereon.

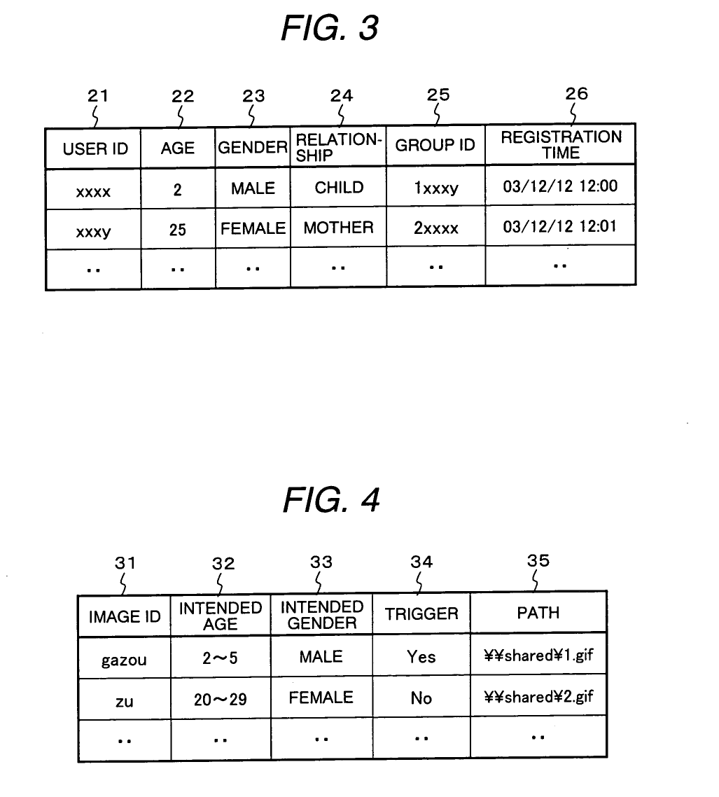

The profile data transmission program 11 transmits profile data (which will be described hereunder with reference to FIG. 3) of the mobile device 4.

The profile data management program 12 registers the profile data to be transmitted thereto with the profiles DB 8, and updates or deletes the profile data registered therein.

The key person extraction program 13 acquires profile data, or data on the users 3 which is acquired from a mobile device or from other data acquisition devices such as a camera, analyzes the data, evaluates relationship between users, and determines a user having high importance.

The staying characteristics evaluation program 14 makes a judgment as to whether users stay or not, by judging that users stay in a certain area for a specified period of time when viewed from a display unit or other data acquisition devices.

It should be noted that the profile data management program 12 may be arranged to manage data on the users 3, the acquisition of which has been unsuccessful from the profile data transmission program 11 for a certain period of time, in the profiles DB 8 as history data.

The image display server 2 includes a displaying image management program 15 and an image display control program 16 as programs to be executed thereon.

The displaying image management program 15 accumulates imaged to be displayed on the display unit 1 in the images DB 9 and updates or deletes the images accumulated in the images DB 9. The image display control program 16 controls actual display of images on the display unit 1.

It should be noted that the key person extraction program 13 and the staying characteristics evaluation program 14 may be installed in the image display server 2.

Next, a data structure to be used for the data notification system of the present invention will be described with reference to FIGS. 3 and 4

FIG. 3 is a diagram showing an example of a profile data table to be stored in a profiles DB 8.

FIG. 4 is a diagram showing an example of an image data table to be stored in an images DB 8.

The fields of the profile data table comprise: as shown in FIG. 3, a user ID 21 which is an identifier of the users 3; age 22 and gender 23 which are attribute data of the users; and registration time 26 which shows the registration time of the image data in the profiles DB 8. Here, the attribute data of a user may include user data on tastes and interests.

The fields of the profile data table further comprise relationship 24 which shows relationship with other users 3 and a group ID 25 which shows identifiers of groups to which the users 3 belong. The users having the same group ID 25 shall belong to the same group. By managing groups in the manner described above, it is possible to manage the users 3 when they belong to a plurality of groups.

It should be noted that, the relationship 24 in FIG. 3 shows relationship that is uniquely determined within a family. The relationship shows an example of what is called a nuclear family in which the relationship between the mother and a child is defined uniquely.

The fields of the image data table comprise: an image ID 31 which is an identifier of an image; intended age 32 which covers the range of ages of intended users for which the image is displayed; intended gender 33 which shows sexuality of intended users for which the image is displayed; a trigger 34 which shows whether the image to be displayed is an image to be displayed for the users 3 having high importance; and a path 35 which shows storage destination of the image. For a child of a lower intended age, for example, it is possible to display an image of a popular cartoon character, thus attracting attention of the child.

In addition, although not shown in the figure, it is possible, by adding a field intended for a specific group, to display advertising images of games or of household appliances when the group to be indicated by the field is intended for families; to display advertising images related to business types when the group to be indicated by the field is intended for companies; or to display advertising of painting tools when it is intended for painting clubs.

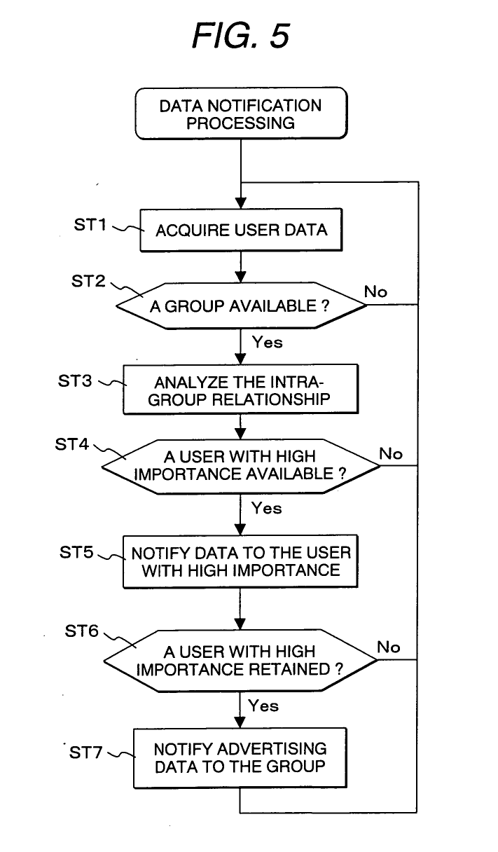

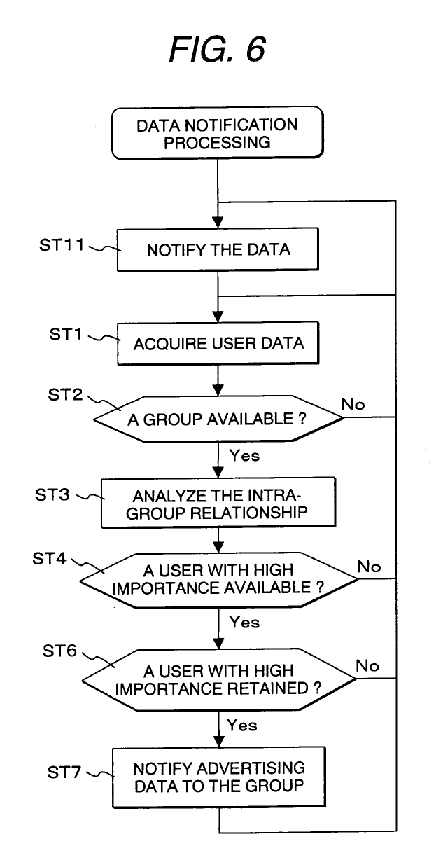

Next, processes of a data notification system according to the first embodiment of the present invention will be described with reference to FIGS. 5 and 6.

FIGS. 5 and 6 are flow charts showing processes of the data notification system according to the first embodiment of the present invention.

First, processes of a data processing system according to the embodiment will be described, while referring to the flow chart shown in FIG. 5 step by step.

First, profile data of users are acquired from the mobile device 4 carried by the users via the radio station 5 (ST1). Alternatively, user data may be acquired from a camera or a sensor.

The data thus acquired is processed by the profile data management program 12 of the data processing server 6.

Next, the data processing server 6 makes a judgment as to whether the users form a group or not (ST2).

In the judgment to determine whether the users form a group or not, users who are judged to belong to the same group are the users 3 with whom the same group ID 25 is registered with the profile data shown in FIG. 3. Alternatively, the users who are judged to belong to the same group may be users 3 who are registered in the profiles DB 8 in the same timing. Here, the judgment of the same timing to register users shall be defined, for example, to be five seconds before and after another registration. Here, when a plurality of data processing servers 6 are available, the judgment may be made by inquiring other data processing servers 6 to define only a group of users 3, who are judged by the specified number or more of the data processing server 6 to be in a same group, as the group.

In addition, through measurement based on positional relationship of the radio station 5, devices such as a sensor and a camera acquiring data, and a display unit, it can be defined that the users form a group when: users stay in a same area for a specified period of time; or users are authorized to stay in a same area in a same time zone. Further, when it is arranged to capture movements of users in a plurality of areas, it may be defined that users who are together in the specific number of areas form a group.

When it is judged there is no group in step ST2, then the step goes to step ST1. If it is judged there is a group in step ST2, then the step goes to step ST3.

When it is judged there is a group, relationships among all users belonging to the group are analyzed by the key person extraction program 13 (ST3). When the presence of a group is judged based on profiles data, values of the relationship 24 and the group ID 25 are acquired from the profiles DB 8 as intra-group relationship data and the data is analyzed. In addition, when user data is acquired from a camera, etc., relationship among users within the group is analyzed based on the image acquired.

Next, a user having high importance is identified based on the analysis made in ST3 (ST4). For example, the user 3 whose age is lowest in the group, or the user 3 who is found to be in the highest order from the relationship data in the group is judged to have high importance.

More specifically, in the former case, for example, a “family” is assumed as a group, and among users who are stated “child” in the relationship 24 of the profile data, the user 3 having the lowest age 22 is judged to be a user having high importance. In this case, the user whose height is lowest among users in the group may be determined to be the user having high importance. The height may be detected with human body detection sensors located at different levels or detected through image processing, or otherwise, may be detected from an item “height” in the profiles DB 8 by newly adding the item.

In the latter case, for example, an organization such as a company is assumed as a group, and the user 3 whose relationship is identified to be senior by other users 3 is judged to be the user having high importance.

Further, another method for determining a user having high importance is to assume relationship through image recognition for a user whose data on the relationship 24 and the same group ID 25 are not registered, or for a user whose profile data cannot be acquired. For example, a user who is found, through tracking of visual lines of the user 3, to have the longest cumulative time during which the user is looked on by the user 3 other than himself or herself. Alternatively, a user who keeps the leading position for a long time is assumed based on data on moving directions and actions of users, and the user is determined to be the user having high importance. Here, when there are a plurality of groups, a user having high importance is chosen from a group having the largest number of users. Alternatively, a user having high importance may be chosen from a group having a longer period of staying time. It should be noted that a plurality of users having high importance may be chosen.

Further, for a case of an exhibition, etc., a user belonging to the most popular category, as determined based on data on visits of users, may be determined to be the user having high importance. For example, when many customers are in their 10s of age, users who appear in the field of age 22 from 10 to 19 may be determined to be the user having high importance. In addition, the users 3 may set the person having high importance via the mobile device 4.

When no user having high importance is judged to be available in step ST4, the step returns to step ST1. If it is judged in step ST4 that a user having high importance is available, image data is acquired from the image data table by the image display control program 16 of the image display server 2. Then, an image intended for the users 3 who is judged to be the user having high importance is displayed on the display unit 1 (ST5).

Next, for a case where a certain period of time has elapsed since the user having high importance was registered, the staying characteristics evaluation program 14 judges whether the users 3 belonging to the group stays or not (ST6).

Judgment of staying can be carried out in the manner that the user having high importance stays for a certain period of time in a same area when viewed from data-acquisition devices such as a display unit or a radio station, by utilizing a position recognition technology by using image processing, or a technology offering more precise position recognition such as an RFID.

In addition, staying may be determined by a condition that the user having high importance has come close to a data-acquisition device such as a display unit or a radio station for a certain period of time or over.

Alternatively, staying may be determined in the manner to make a judgment based on a condition that a user having high importance has come close, within a certain distance, to a data-acquisition device such as a display unit or a radio station. Here, the term “for a certain period of time” may be defined to be a period of time equivalent to a time period during which an image is displayed in step ST5, or alternatively, the period may be defined to be 30 seconds, for example, without being bound by the above-described method.

Further, staying may be determined by a condition that the user having high importance has performed any input operations on a display unit or a terminal unit.

Here, the user to be judged whether he or she stays or not may be a certain number or more of users in a group or may be all users in the group.

If it is not judged that the user having high importance is present, the process returns to step ST1.

If it is judged that the user having high importance is present in step ST6, common advertising data is provided to the group by the display image control program 16 via the display unit 1 (ST7). Alternatively, the common data is displayed to users in the group except the user having high importance.

For example, when family members form a group and the user having high importance is a child in the family, images such as cartoons which attract interests of the child will be displayed to the child who is the user having high importance, and advertising of toy shops or children's cloths are displayed to other family members or the parents.

The data to be displayed here includes advertising data, guidance data, etc. Regarding the mode of notifying data, image data may be displayed on the display unit 1 shown in FIG. 1, or data may be notified via voices through devices such as a speaker.

Further, the data to be notified may be associated with each other at time points before and after the user determined to have high importance or all users in the group come to be in a staying status. As for the example described above, a case where advertising will be displayed to the parents when the child is interested in a cartoon and makes a halt falls under this case.

In addition, the mode of display at time points before and after the user determined to have high importance or all users in the group come to be in a staying status may be modified in various ways.

For example, it is also possible to display data that is required to be highlighted in a noticeable way, by modifying the notification position, size and amount of data according to display data at time points before and after the staying. Further, the data to be displayed after the staying may be displayed either at the upper part, the lower part, the right side or the left side of the data to be displayed before the staying.

Furthermore, it may be arranged in the manner that, considering the positional relationship between the user having high importance and other users in the group, the data to be displayed after the staying of the user determined to have high importance may be displayed either on the front/back or the right/left side of the user having high importance, or otherwise, either at the forward or the backward position in a moving direction of the user having high importance. The reason for the arrangement is that, since the user having high importance attracts the attention of other users, displaying of data at a position closer to the user having high importance would facilitate the data to be captured by the user having high importance.

In addition, for the similar reason, after the user having high importance has stayed, data may be displayed on a display unit that is installed in the vicinity of a location on an extended line of a line connecting other users in the group and the user determined to have high importance.

For example, with the example shown above, when the user having high importance is a child, the parents should usually direct their eyes on their child when the child made a halt. This is the reason why data to be notified to the child will be displayed on the extended line of their visual lines.

Further alternatively, if display is made on a display unit or a terminal unit in a regular state, when the user having high importance performs an input operation on the display unit or the terminal unit, it may be judged as a staying status for notification of display-only data in a one-way manner.

Next, a variation of the data notification system according to the embodiment will be described with reference to FIG. 6.

The example shown in FIG. 6 exemplifies a case where data is steadily provided and advertising data to a group is provided when a user having high importance is in a staying status.

With the example, an image is chosen from images stored in the images DB 9 and display of the image is steadily performed on the display unit 1 by the image display control program 16 (ST11). Upon completion of display of the image, the process goes to step ST1, wherein processing is executed in a similar way to the flow shown in FIG. 5. With the display example, a mode in which data like a neon sign on the street is continuously displayed is assumed.

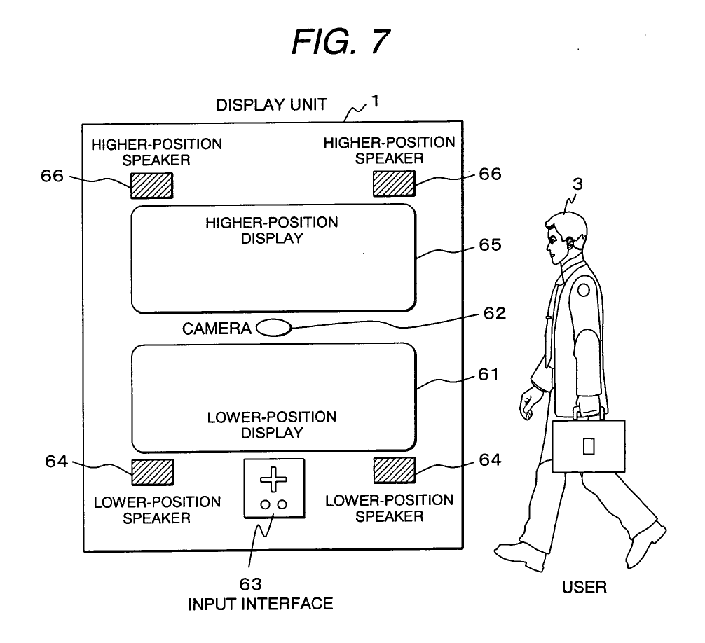

Next, an example of the display unit of the data notification system according to the embodiment of the present invention will be described with reference to FIG. 7.

FIG. 7 is a diagram showing an example of the display unit of the data notification system according to the embodiment of the present invention.

The display unit 1 is characterized that it includes a plurality of displays, thus allowing for two types of displaying method.

The display unit 1 includes an input interface 63, a camera 62, a lower-position speaker 64, and a lower-position display 61, which are installed at lower positions, and a higher-position speaker 66, and a higher-position display 65, which are installed at higher positions.

The devices installed at lower-positions are installed at levels that enable a child to view the devices, and the devices installed at higher-positions are installed at positions higher than the child's height. The input interface 63 is an input device such as a joystick.

The lower-position speaker 64 and the higher-position speaker 66 are devices to output voices and they are connected to the lower-position display 61 and the higher-position display 65, respectively.

For a case where the display unit 1 is applied to the data notification system of the embodiment, the above-described group should be a family. In this case, the display unit can be used effectively in such ways: displaying content such as a cartoon for children on the lower-position display 61 when the user having high importance is a child; and, displaying advertising of shops such as a toy shop or a video shop related to cartoons to be viewed by the adult users 3, when the child is in a staying status and starts using the input interface 63 of the lower-position display 61 on the higher-position display 65.

### Second Embodiment

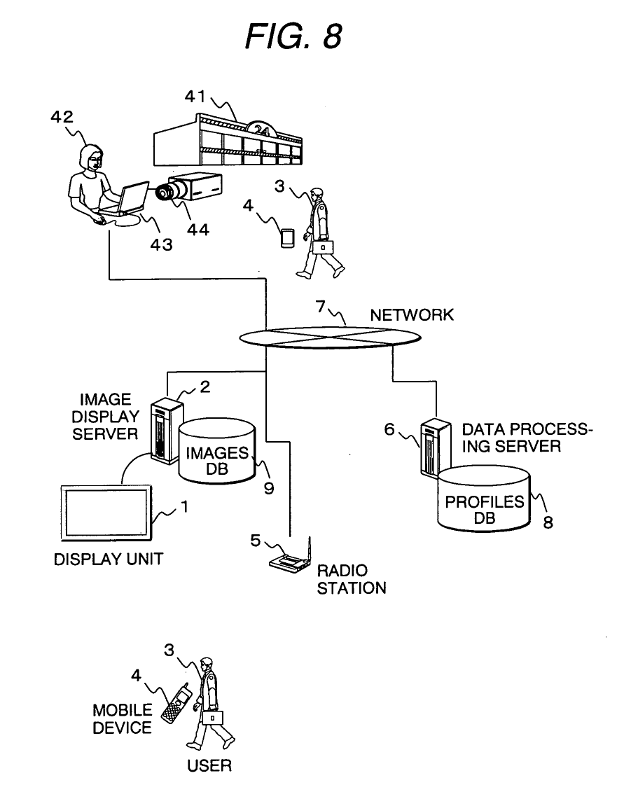

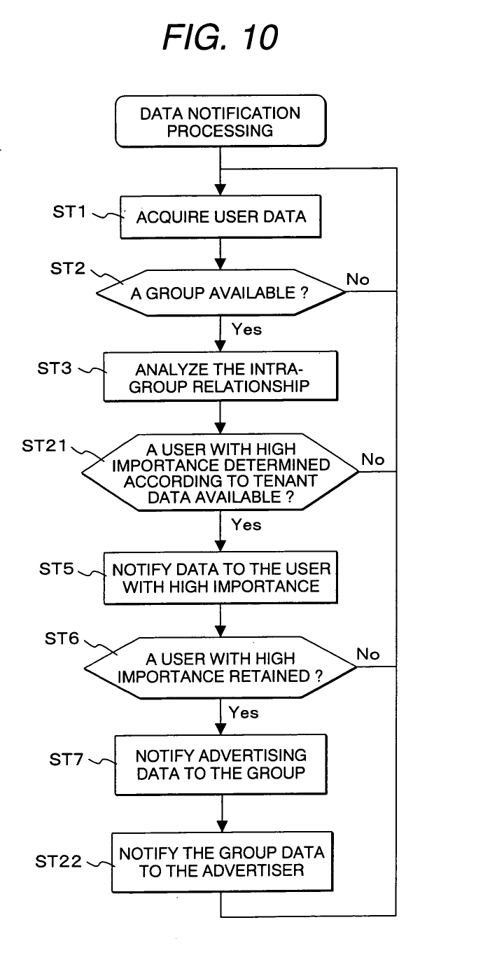

Hereinafter, a second embodiment according to the present invention will be described with reference to FIG. 8 and FIG. 10.

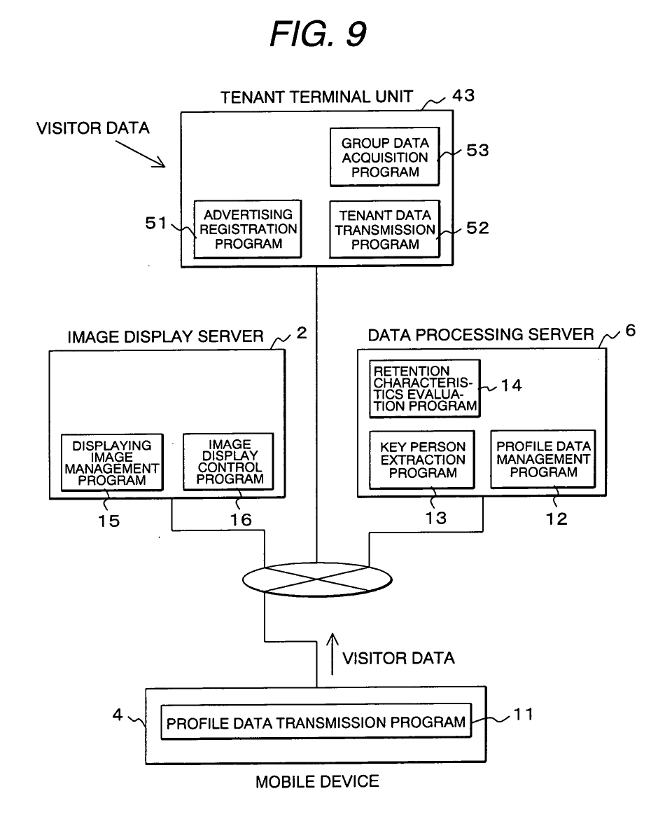

First, a configuration of a data notification system according to the second embodiment of the present invention will be described with reference to FIGS. 8 and 9.

FIG. 8 is a configuration diagram of the data notification system according to the second embodiment of the present invention.

FIG. 9 is a software configuration diagram of the data notification system according to the second embodiment of the present invention.

The embodiment refers to a system wherein data on tenants which are connected via a network is provided, according to the statuses of groups of users located in the vicinity of the display unit, by a display unit installed in a public space to which many users visit.

The data notification system shown in FIG. 8 is a system which is realized by adding a tenant 41, an advertiser 42, a tenant terminal unit 43 and an in-tenant camera 44 to the system shown in FIG. 1.

The tenant 41 is a tenant owned by the advertiser 42, and the users 3 visit thereto as customers. For example, the tenant 41 can be a coffee house, a Japanese-style bar, a food store, a clothing store, a barber, a beauty shop, an amusement arcade, etc. The advertiser 42 will make advertising on the display unit 1 by using the tenant terminal unit 43. The in-tenant camera 44 is used to take pictures of the status in the shop.

The software configuration of the data notification system of the embodiment is shown in FIG. 9.

The data notification system shown in FIG. 9 is a system which is realized by adding an advertising registration program 51, a tenant data transmission program 52, and a group data acquisition program 53 to the data notification system shown in FIG. 2. Either of these programs runs on the tenant terminal unit 43.

The advertising registration program 51 registers advertising set out by the advertiser 42 to the displaying image management program 15.

The tenant data transmission program 52 notifies tenant data in responding to a request from the key person extraction program 13. The group data acquisition program 53 acquires data on the group in the staying status from the staying characteristics evaluation program 14, and the program 53 also sends a notification to the advertiser 42.

Next, processing of the data notification system according to the second embodiment of the present invention will be described with reference to FIG. 10.

FIG. 10 is a flow chart showing processes of the data notification system according to the second embodiment of the present invention.

As with the first embodiment, the intra-group relationship is analyzed (ST3) after processing acquisition of user data (ST1) and judgment of a group (ST2). Then, according to the tenant data, a judgment is made as to whether a user having high importance is available (ST21). Here, in this step, the key person extraction program 13 acquires tenant data by using the tenant data transmission program 52 for a judgment whether a user having high importance is available or not. Here, the visitor data in the tenant 41 is formatted for storage in the profiles DB 8 and registered therein.

For example, for a case where data is acquired with a camera and is written in the profile data fields shown in FIG. 3, data in the field of the age 21 will be stated with an extended range, and the fields of the group ID 25, the user ID 21 and the relationship 24 will be left blank. From the data, one or more fields of the gender 23 and the age 22 of visitors among those in the tenant 41 are chosen. When a user of a group satisfying the values that are found to be most redundant in the data is available, the user is determined to have high importance. Alternatively, visitor data may be set out based on the data on users who have finished paying bills at the pay counter. Alternatively, in addition to the visitors at the time, history data for one hour, for example, may be set out as visitor data. When it is judged that a user having high importance is available in step ST21, the process goes to step ST5. When it is not judged a user having high importance is available, the process goes to step ST1. Further, when advertising data is notified to a group (ST7), the process goes to step ST22, and data on the group to which advertising is notified to the advertiser 42 via the group data acquisition program 53 (ST22). Thereafter, the process returns to ST1.

[Applications of the Present Invention]

According to the present invention, in a data notification system that is installed in a place of a public space to which many people visit, it is possible, while paying a conscious attention to a user having high importance in the group, to notify data to users who visit a shop in a group to make the group to stay in a place where the group can access the data more frequently. Consequently, the present invention can be applied to intended purposes which require provision of data to many users in a public space, etc.

1. A data notification method for a system comprising:
a data acquisition device to acquire data of an intended person to whom the data is notified;
a data notification device to notify the data to the intended person; and
a data processing server which is connected to said data acquisition device and said data notification device and processes data acquired from said intended person,
said method comprising the steps of:
allowing said data notification device to acquire data of said intended person;
allowing said data processing device to make a judgment as to whether or not a plurality of intended persons to whom the data is notified form a group based on the data of said intended person; and
allowing said data notification device to notify the data to said plurality of intended persons based on the result of the step of making a judgment as to whether or not said plurality of intended persons form a group.

2. A data notification method according to claim 1, wherein, in the step of making a judgment as to whether said plurality of intended persons form a group or not, a judgment is made that intended persons to whom the data is notified form a group,
when a relationship is found among said intended persons based on profile data owned by said intended persons; or,
when said intended persons are present in the same area for a specific period of time, in the same area in a same time zone, or in a certain number or more of areas all together, as viewed from the positional relationship with said data acquisition device or said data notification device.

3. A data notification method according to claim 1,
wherein the data of the intended person to be acquired from said data acquisition device includes at least one of: attribute data of the intended person; location data of the intended person; movement data of the intended person; position-related data with other persons in a group to whom the data is notified; action data of the intended person; and view-line data of the intended person.

4. A data notification method according to claim 1, said method further comprising the steps of:
calculating a level of importance of intended persons forming a group to whom the data is notified based on the data of the intended persons acquired from said data acquisition device;
making a judgment that the intended person to whom the data is notified who is determined to have high importance in the step of calculating a level of importance of intended persons forming a group to whom the data is in a staying status, in view of the positional relationship with said data acquisition device or said data notification device; and
executing data notification by using said data notification device to said all intended persons to whom the data is notified who are determined to have high importance, or to intended persons to whom the data is notified other than said intended persons to whom the data is notified who are determined to have high importance, when said intended persons to whom the data is notified who are determined to have high importance is judged to be in a staying status in the step of making a judgment that said intended persons to whom the data is notified who are determined to have high importance.

5. A method data notification method according to claim 4, wherein said intended persons to whom the data is notified who are determined to have high importance is judged to be in a staying status in the step to make a judgment that said intended persons to whom the data is notified who are determined to have high importance is in a staying status based on the positional relationship with said data acquisition device or said data notification device, when at least one of the following conditions is satisfied:
said intended persons to whom the data is notified who are determined to have high importance have been in a same area for a certain period of time or longer when viewed from said data acquisition device or said data notification device;
said intended persons to whom the data is notified who are determined to have high importance has reduced a distance from said data acquisition device or said data notification device for a certain period of time or longer;
said intended persons to whom the data is notified who are determined to have high importance have come closer to said data acquisition device or said data notification device within a certain distance; or
said intended persons to whom the data is notified who are determined to have high importance have made an input on said data acquisition device or said data notification device.

6. A method data notification method according to claim 1, said method further comprising steps of:
calculating the level of importance of intended persons forming a group to whom the data is notified based on the data of the intended persons to whom the data is notified acquired from said data acquisition device;
executing data notification by using said data notification device to the intended persons to whom the data is notified who are determined to have high importance in the step of calculating the level of importance of intended persons forming a group;
making a judgment that said group is in a staying status based on the positional relationship with said data acquisition device or said data notification device, after executing data notification by using said data notification device to the intended persons to whom the data is notified who are determined to have high importance; and
when said group is in a staying status in the step of making a judgment that said group is in a staying status, executing data notification by using said data notification device to said all intended persons forming a group to whom the data is notified or to intended persons to whom the data is notified other than said intended persons to whom the data is notified who are determined to have high importance.

7. A method data notification method according to claim 6, wherein said group is judged to be in a staying status in the step of making a judgment that said group is in a staying status based on the positional relationship with said data acquisition device or said data notification device, when at least one of the following conditions is satisfied:
a certain number or more of the intended persons in said group to whom the data is notified or said all intended persons in said group to whom the data is notified have been in the same area for a specific period of time or longer as viewed from said data acquisition device or said data notification device;
a certain number or more of the intended persons in said group to whom the data is notified or said all intended persons in said group to whom the data is notified have reduced a distance for a specific period of time or longer from said data acquisition device or said data notification device;
a certain number or more of the intended persons in said group to whom the data is notified or said all intended persons in said group to whom the data is notified have come closer to said data acquisition device or said data notification device within a certain distance; and
said intended persons to whom the data is notified who are determined to have high importance have made an input on said data acquisition device or said data notification device.

8. A data notification system, said system comprising:
a data acquisition device to acquire data of an intended person to whom the data is notified;
a data notification device to notify the data to the intended person; and
a data processing server which is connected to said data acquisition device and said data notification device and processes data acquired from said intended person;
wherein data of said intended person to whom the data is notified is acquired by said data acquisition device;
a judgment is made as to whether or not a plurality of intended persons to whom the data is notified form a group based on said data of the intended person acquired by said data processing device; and
data notification is executed by said data notification device to said intended persons to whom the data is notified based on the judgment result as to whether said plurality of intended persons to whom the data is notified form a group or not.

9. A data notification system according to claim 8,
wherein said data notification device executes data notification to said intended persons to whom the data is notified by using at least one of audio data and image data.

10. A data notification system according to claim 8, wherein:
a level of importance of intended persons forming a group to whom data is notified is calculated based on data of the intended persons to whom data is notified that is acquired from said data acquisition device;
a judgment is made that said intended persons to whom data is notified are in a state of staying based on the positional relationship with said data acquisition device or said data notification device, when at least one of the following conditions is satisfied:
said intended persons to whom the data is notified who are determined to have high importance have been in the same area for a certain period of time or longer when viewed from said data acquisition device or said data notification device;
said intended persons to whom the data is notified who are determined to have high importance has reduced a distance from said data acquisition device or said data notification device for a certain period of time or longer;
said intended persons to whom the data is notified who are determined to have high importance have come closer to said data acquisition device or said data notification device within a certain distance; and
said intended persons to whom the data is notified who are determined to have high importance have made an input on said data acquisition device or said data notification device; and
when said intended persons to whom the data is notified who are determined to have high importance are judged to have been in a staying status, data notification is executed by using said data notification device to said all intended persons forming a group to whom the data is notified or to intended persons to whom the data is notified other than said intended persons to whom the data is notified who are determined to have high importance,.

11. A data notification system according to claim 10,
wherein association is made with the data to be notified by using said data notification device at points before and after said intended persons to whom the data is notitied who are determined to have high importance are in a staying status.

12. A data notification system according to claim 8,
wherein different modifications are made in the notification position, the size and the amount of data between data to be notified to said intended persons to whom the data is notified who are determined to have high importance before said intended persons to whom the data is notified who are determined to have high importance are in a staying status, and data to be notified to said intended persons to whom the data is notified after said intended persons to whom the data is notified who are determined to have high importance have been in a staying status.

13. A data notification system according to claim 12,
wherein, when a modification is made to data to be notified to said intended persons to whom the data is notified, the data, which is to be notified to said intended persons to whom the data is notified after said intended persons to whom the data is notified who are determined to have high importance has been in a staying status, is notified before said intended persons to whom the data is notified who are determined to have high importance is in a staying status, by displaying such data at a position which satisfies at least one of the following positions of the upper, the lower, the right side and the left side of the displayed data that is to be notified to said intended persons to whom the data is notified.

14. A data notification system according to claim 12,
wherein, when a modification is made to data to be notified to said intended persons to whom the data is notified, the data, which is to be notified to said intended persons to whom the data is notified after said intended persons to whom the data is notified who are determined to have high importance has been in a staying status, is notified by displaying such data at a position which satisfies at least one position of:
the forward, the backward, the right side and the left side of the intended persons to whom the data is notified who are determined to have high importance; and
the forward and the backward side of the moving direction of the intended persons to whom the data is notified who are determined to have high importance.

15. A data notification system according to claim 12,
wherein, a modification is made to data to be notified to said intended persons to whom the data is notified, data notification is executed by displaying data, which is to be notified to said intended persons to whom the data is notified after said intended persons to whom the data is notified who are determined to have high importance has been in a staying status, in the vicinity of a location on an extension of a line connecting intended persons to whom the data is notified other than said intended persons to whom the data is notified who are determined to have high importance in said group with the intended persons to whom the data is notified who are determined to have high importance.

16. A data notification system according to claim 12,
wherein, said data notification device executes two-way data exchange with said intended persons to whom the data is notified at a time point before the intended persons to whom the data is notified who are determined to have high importance are in a staying status, and executes one-way data notification at a time point after the intended persons to whom the data is notified who are determined to have high importance has been in a staying status.

17. A data notification system according to claim 8, said system further comprising the steps of:
a level of importance of intended persons forming a group to whom the data is notified is calculated based on the data of the intended persons to whom the data is notified acquired from said data acquisition device;
data notification is executed by using said data notification device to the intended persons to whom the data is notified who are determined to have high importance;
after the data notification is executed by using said data notification device to the intended persons to whom the data is notified who are determined to have high importance,
a judgment is made that said group is in a staying status as viewed from the positional relationship with said data acquisition device or said data notification device, when at least one of the following conditions is satisfied:
a certain number or more of the intended persons in said group to whom the data is notified or said all intended persons in said group to whom the data is notified have been in the same area for a specific period of time or longer as viewed from said data acquisition device or said data notification device;
a certain number or more of the intended persons in said group to whom the data is notified or said all intended persons in said group to whom the data is notified have reduced a distance for a specific period of time or longer from said data acquisition device or said data notification device;
a certain number or more of the intended persons in said group to whom the data is notified or said all intended persons in said group to whom the data is notified have come closer to said data acquisition device or said data notification device within a certain distance; and
said intended persons to whom the data is notified who are determined to have high importance have made an input on said data acquisition device or said data notification device; and
when the judgment is made that said group is in a staying status, data notification is executed by using said data notification device to said all intended persons forming a group to whom the data is notified or to intended persons to whom the data is notified other than said intended persons to whom the data is notified who are determined to have high importance.

18. A data notification system according to claim 17,
wherein association is made with the data to be notified by using said data notification device at points before and after said group is in a staying status.

19. A data notification system according to claim 17,
wherein modifications of the notification position, the size and the amount of data are made between data to be notified to said intended persons to whom the data is notified before said group is in a staying status, and data to be notified to said intended persons to whom the data is notified after said group has been in a staying status.

20. A data notification system according to claim 17,
wherein, when a modification is made to data to be notified to said intended persons to whom the data is notified, the data, which is notified to said intended persons to whom the data is notified after said group has been in a staying status, is notified by displaying such data at a position which satisfies at least one position of the upper, the lower, the right side and the left side of the displayed data that is to be notified to said intended persons to whom the data is notified before said group is in a staying status.

21. A data notification system according to claim 17,
wherein, when a modification is made to data to be notified to said intended persons to whom the data is notified, the data, which is to be notified to said intended persons to whom the data is notified after said group has been in a staying status, is notified by displaying such data at a position which satisfies at least one position of: the forward, the backward, the right side and the left side of the intended persons to whom the data is notified who are determined to have high importance; and the forward and the backward side of the moving direction of the intended persons to whom the data is notified who are determined to have high importance.

22. A data notification system according to claim 17,
wherein, when a modification is made to data to be notified to said intended persons to whom the data is notified, data notification is executed by displaying data, which is to be notified to said intended persons to whom the data is notified after said group has been in a staying status, in the vicinity of a location on an extension of a line connecting intended persons to whom the data is notified other than said intended persons to whom the data is notified who are determined to have high importance in said group with the intended persons to whom the data is notified who are determined to have high importance.

23. A data notification system according to claim 17,
wherein, said data notification device executes two-way data exchange with said intended persons to whom the data is notified at a time point before said group is in a staying status, and executes one-way data notification to said intended persons to whom the data is notified at a time point after said group has been in a staying status.
